(19) United States
(12) Patent Application Publication
(10) Pub. No.: US 2012/0066270 A1
(43) Pub. Date: Mar. 15, 2012

(54) AUTOMATED MEMORY MANAGEMENT OF INDEXED DATA USING WEAK REFERENCES

(75) Inventor: Alexander Kravets, Marina del Rey, CA (US)

(73) Assignee: ALELO, INC., LOS ANGELES, CA (US)

(21) Appl. No.: 12/880,914

(22) Filed: Sep. 13, 2010

(51) Int. Cl. G06F 7/00

(52) U.S. Cl. 707/812; 707/802; 707/E17.044

(57) ABSTRACT

Memory may be managed by a garbage collector. The memory may contain a data structure and an index. The data structure may include a plurality of objects. The index may index a plurality of the objects in the data structure. For each object which it indexes, the index may contain a key field and a weak reference to the object. The key field may be indicative of an attribute of the object. The weak reference to the object may be associated with the key field. The weak reference may have a configuration which is not followed by a pointer tracer of the garbage collector when the garbage collector seeks to determine which of the objects in the data structure are no longer reachable from outside of the data structure during a memory reclamation process. This may insure that the index does not prevent the memory occupied by any unreachable object in the data structure from being reclaimed by the garbage collector during the memory reclamation process, even though the object is still referenced by the index. References in a reference reclamation queue generated by the garbage collector may be used to identify and remove entries in the index to objects whose memory has been reclaimed by the garbage collector.

### BACKGROUND

1. Technical Field

This disclosure relates to automated memory management, including the reclamation of memory used by objects which are no longer reachable outside of the data structure in which they are members.

2. Description of Related Art

Complex, graph-like, in-memory, data structures which contain a large number of objects (e.g., in excess of 1000) may be suited to representing various domains. However, navigating and searching through them to respond to queries for specific objects may require an index for efficiency. The index may avoid the necessity to traverse long paths or to perform linear scans which might result in unacceptable query response times.

One indexing technique is to assign a unique, immutable key to each object and to maintain a separate index table which maps such keys to the individual objects. Objects in the table may be looked up using constant O(1) time using hashing techniques.

Using index tables, however, does not come without a cost. Modern platforms (e.g., JVM, .NET, and Flash) provide automated memory management using what is known as a “garbage collector.” The garbage collector is configured to reclaim memory which is occupied by objects which are no longer in use by an application program.

To determine whether an object is no longer in use, garbage collectors typically determine whether the object is “reachable” from outside of the data structure in which the object resides. This typically means that the object is referenced from outside of the data structure or by an object within the data structure which itself is reachable from outside of the data structure.

Unfortunately, index tables are themselves viewed by the garbage collector as objects which are reachable from outside of the data structure. Thus, even when an indexed object becomes unreachable, a garbage collector may regard the object as still being reachable, since it is still reachable through the index table which references it.

As a consequence, index tables may frustrate the automatic memory management which is provided by garbage collectors. Application programmers, therefore, have been compelled to write ad-hoc memory management routines within their application programs to manually reclaim memory occupied by indexed objects which, but for the index, have become unreachable. This can increase the size, cost, and complexity of application programs.

### SUMMARY

Non-transitory, tangible, computer-readable memory may be managed by a garbage collector. The memory may contain a data structure and an index. The data structure may include a plurality of objects. The index may index a plurality of the objects in the data structure. For each object which it indexes, the index may contain a key field and a reference to the object. The key field may be indicative of an attribute of the object. The reference to the object may be associated with the key field. The reference may have a format which does not prevent the garbage collector from reclaiming memory occupied by any unreachable object in the data structure, even though the object is still referenced by the index.

All of the references to each object in the index may be weak references.

The data structure may include a plurality of object groups.

The data structure may be an arbitrary data structure, arbitrarily complex, and/or a cyclical data structure.

The objects may include nodes and edges of a graph.

The index may be implemented as a hash map.

Non-transitory, tangible, computer-readable storage media may contain computer-readable instructions which, when executed by a computer system, cause the computer system to generate and write the data structure and the index into the memory.

The garbage collector may be configured to create a reference reclamation queue containing references to objects whose memory has been reclaimed by the garbage collector.

The instructions, when executed by the computer system, may cause the computer system to read the references in the reference reclamation queue.

The instructions, when executed by the computer system, may cause the computer system to remove entries in the index to objects whose memory has been reclaimed by the garbage collector, as indicated by the references in the reference reclamation queue.

The instructions may be part of an application program which is separate from the garbage collector and which does not contain any instructions which reclaim memory occupied by any of the objects in the data structure which are no longer reachable from outside of the data structure.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings illustrate illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an example of a computer system which may generate and store a data structure and an index to that data structure.

FIG. 2 is an example of a memory management process performed by the computer system illustrated in FIG. 1.

FIG. 3 is an example of the data structure illustrated in FIG. 1.

FIG. 4 is an example of the index illustrated in FIG. 1.

FIG. 5 is an example of the data structure illustrated in FIG. 1 after a reference to one of the objects has been removed.

FIG. 6 is an example of the data structure illustrated in FIG. 5 after the memory occupied by objects which were no longer reachable from outside of the data structure is automatically reclaimed by the garbage collector illustrated in FIG. 1, notwithstanding that some of the reference were still referenced in the index.

FIG. 7 is an example of a reference reclamation queue created by the garbage collector illustrated in FIG. 1 after reclaiming the memory as illustrated in FIG. 6.

FIG. 8 is an example of the index which is illustrated in FIG. 1 after entries which refer to unreachable objects have been removed by the application program illustrated in FIG. 1.

### DETAILED DESCRIPTION OF ILLUSTRATIVE EMBODIMENTS

Illustrative embodiments are now described. Other embodiments may be used in addition or instead. Details which may be apparent or unnecessary may be omitted to save space or for a more effective presentation. Some embodiments may be practiced with additional components or steps and/or without all of the components or steps which are described.

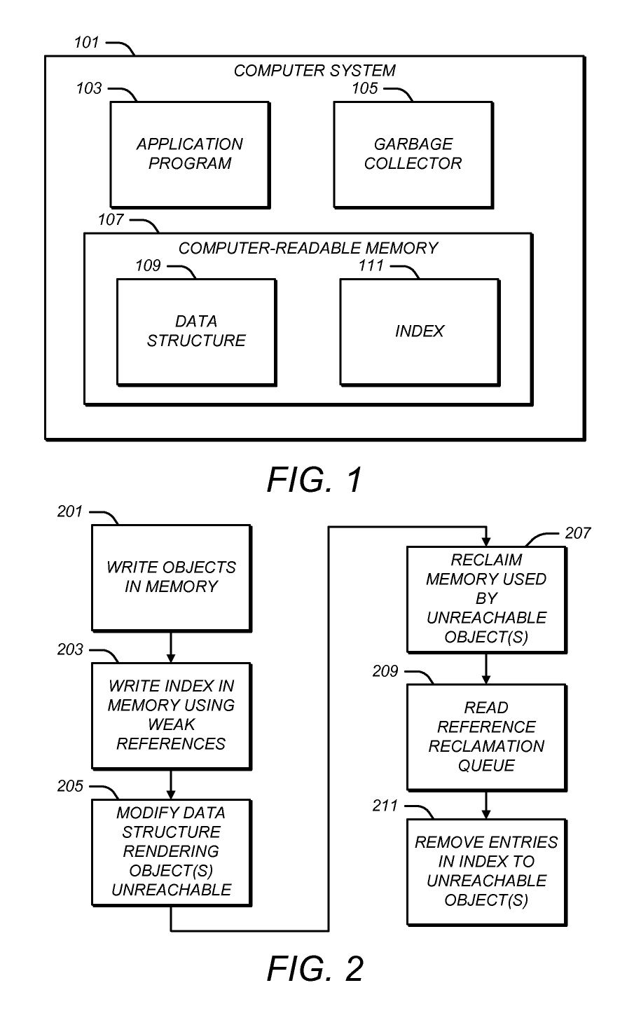

FIG. 1 is an example of a computer system 101 which may generate and store a data structure 109 and an index 111 to that data structure 109.

FIG. 2 is an example of a memory management process performed by the computer system 101 illustrated in FIG. 1. The process may be performed by other computer systems. The computer system 101 may perform other processes.

As illustrated in FIG. 1, the computer system 101 may include an application program 103, a garbage collector 105, and computer readable memory 107 containing the data structure 109 and the index 111. The computer system 101 may contain additional components, such as an operating system, and/or not all of the components illustrated in FIG. 1.

The computer-readable memory 107 may be of any type. For example, the computer-readable memory 107 may consist of or include one or more RAMS, ROMS, PROMS, and/or flash memories.

The application program 103 may be a software program of any type. For example, the application program 103 may be a database management program configured to manage data. As part of this management process, the application program 103 may be configured to write data objects in the computer-readable memory 107, as reflected by a Write Objects in Memory step 201 in FIG. 2. The objects may form the data structure 109.

The application program 103 may be configured to generate the index 111 of some or all of the objects and to write the index 111 into the computer-readable memory 107, as reflected by a Write Index in Memory Using Weak References step 203 in FIG. 2. Information about these weak references are set forth below.

The garbage collector 105 may be a software program which is configured to reclaim portions of the computer-readable memory 107 which are occupied by objects within the data structure 109 which are no longer reachable from outside of the data structure 109 during a memory reclamation process.

The garbage collector 105 may be configured to employ a pointer tracer which follows references to objects as part of the process of determining whether the objects are no longer reachable from outside of the data structure 109. The garbage collector may be configured to distinguish between one type of reference called a “strong reference” and another type of reference called a “weak reference.” The pointer tracer may be configured to ignore weak references when determining whether an object is reachable from outside of the data structure 109, i.e., to only consider strong references during this task.

Conventional references between objects in memory are also known as “strong references” in connection with garbage collectors which supports different types of references. For example, a strong reference might refer to an Address object from an Account object, or from an abstract Node inside a Graph to another node linked to it. A weak reference might refer to the Account object from an index which indexes accounts by their account number. Strong references usually endure unless explicitly cleared by the Application code; and they may also make their referents reachable from the object holding the reference and therefore not reclaimable by the garbage collector.

Weak references may be implemented differently on different platforms. For example, on the JVM platform, they may be objects of type java.lang.ref.WeakRef whose field named “referent” refers to the object held through the weak reference. Weak references may not be followed by the garbage collector when determining reachability. If an object is reachable solely by following a weak reference, then it becomes subject to reclamation by the garbage collector and the corresponding weak reference may then be cleared (or set to null) in the objects containing it.

The application program 103 may not include any instructions which reclaim memory occupied by any of the objects in the data structure 109 which are no longer reachable from outside of the data structure 109.

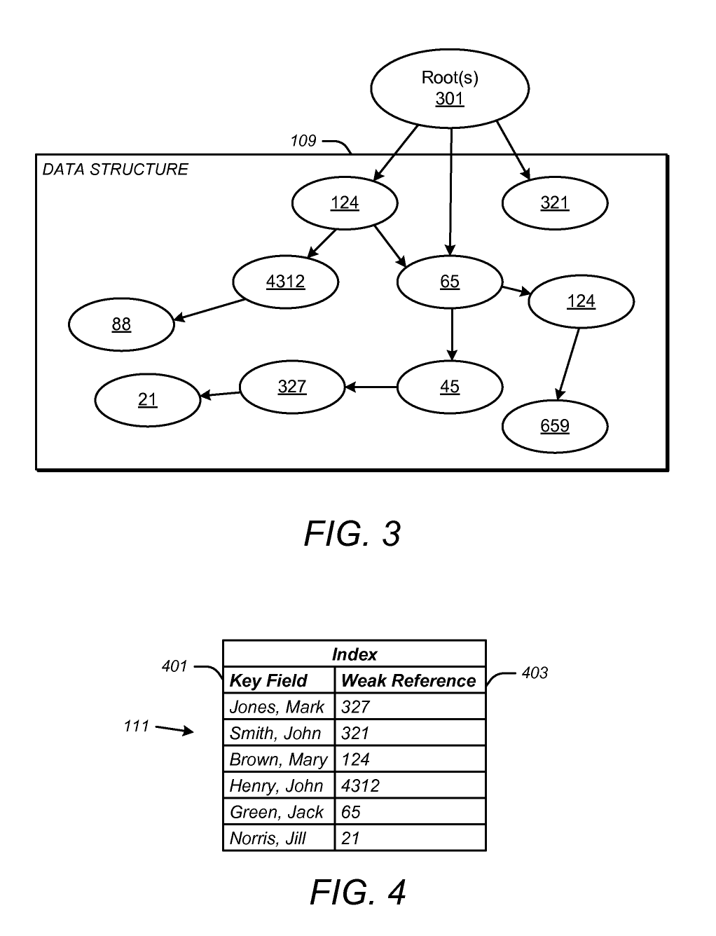

FIG. 3 is an example of the data structure 109 illustrated in FIG. 1. The data structure may be used in connection with other types of computer systems. Similarly, the data structure 109 may be different from what is illustrated in FIG. 3.

As illustrated in FIG. 3, the data structure 109 may include one or more roots 301. The data structure 109 may also contain a plurality of objects, such as objects 124, 321, 4312, 65, 124, 88, 21, 327, 45, and 659. The data structure 109 may be an arbitrary data structure, meaning that it may be a representation of an arbitrary domain, such as financial records, a social network, elements of a supply chain, etc. The data structure 109 may be arbitrarily complex, meaning that objects within the data structure and their topological connectivity pattern can be arbitrarily complex. The data structure 109 may be a cyclical data structure, meaning that it may be possible to return to an object by following a chain of references outgoing from it. In general, the data may be a representation of an arbitrary, multiple-connected, and possibly cyclic Graph.

There may be a strong reference from each root to a respective object, as represented by the arrows pointing from the roots 301 to the objects 124, 321, and 65. Similarly, there may be strong references from certain objects, such as the objects 124 and 65, to other objects, such as the objects 4312 and 45, respectively. Based on the configuration illustrated in FIG. 3, each of the objects which are illustrated may be considered by the garbage collector 105 to be reachable.

FIG. 4 is an example of the index 111 illustrated in FIG. 1. The index illustrated in FIG. 4 may be generated by other types of computer systems. Similarly, the index 111 may be different from what is illustrated in FIG. 4.

The index 111 may include a key field 401 which may be indicative of an attribute of each object. The index 111 may include a weak reference 403 to each object. Each weak reference 403 may be associated with the key field 401 for the object. Each weak reference 403 may have a configuration which is not followed by the pointer tracer of the garbage collector 105 when the garbage collector seeks to determine which of the objects in the data structure 109 are no longer reachable from outside of the data structure 109 during a memory reclamation process. This may thus ensure that the index 111 does not prevent the memory occupied by any object in the data structure 109 which is no longer reachable from outside of the data structure 109 from being reclaimed by the garbage collector 105 during the memory reclamation process, even though the object is still referenced by the index 111.

The index 111 may be in any form. For example, the index may be a table and implemented as a hash map. The index 111 may index a plurality of the objects in the data structure 109, but not necessarily all of them.

The application program 103 may be configured to modify the data structure 109 so as to render one of its objects unreachable, as reflected by a Modify Data Structure Rendering Object(s) Unreachable step 205. This may occur, for example, when the application program 103 removes a strong root reference to an object and/or removes a strong reference in an object to another object.

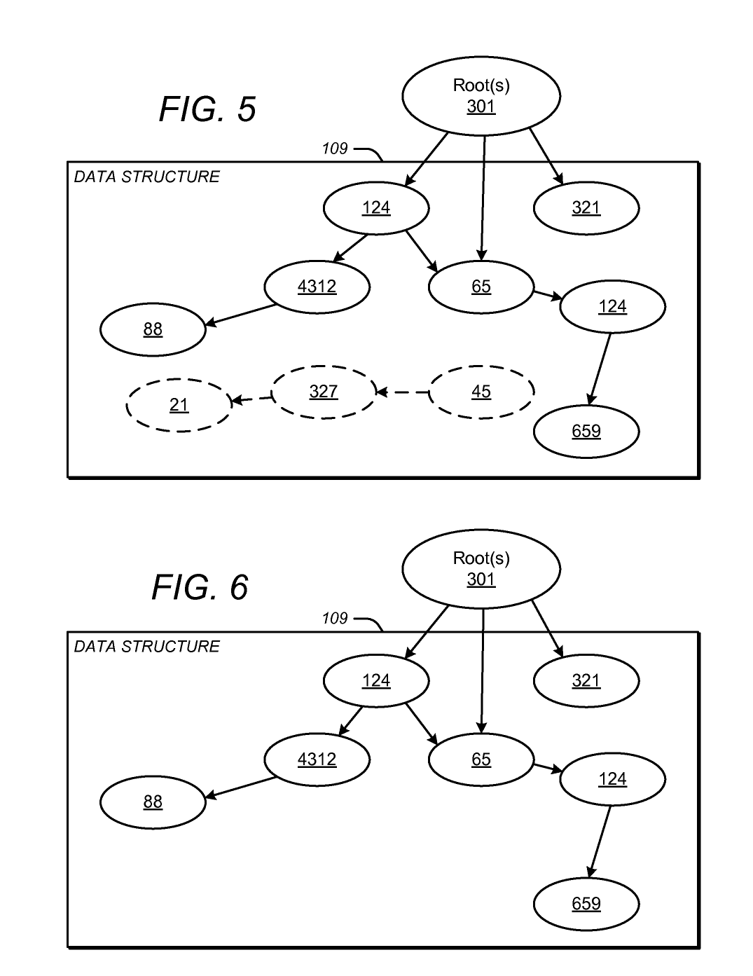

FIG. 5 is an example of the data structure 109 illustrated in FIG. 1 after a reference to one of the objects has been removed. As illustrated by a comparison of FIG. 5 with FIG. 3, the strong reference from object 65 to object 45 has been removed. This may have been caused, for example, by the application program 103 making a change in the object 65. As a consequence, objects 21, 327, and 45 may no longer be reachable from outside of the data structure 109, as indicated by these objects now being shown by broken lines.

The garbage collector 105 may be run next. This may be triggered, for example, by an instruction in the application program 103, by an instruction from an underlying operating system, by a periodic memory management timer, and/or by background operation of the run-time platform.

The garbage collector may reclaim the computer-readable memory 107 which had been occupied by what are not unreachable objects, as reflected by a Reclaim Memory Used By Unreachable Object(s) step 207. During this memory reclamation process, the garbage collector 105 may recognize that objects 21, 327, and 45 are no longer reachable from outside of the data structure 109. As a consequence, the garbage collector 105 may reclaim the memory which is occupied by these objects. This may take place, notwithstanding the fact that one or more of these objects, such as the objects 21 and 327 in the example illustrated in FIG. 4, are still referenced by the index 111. Since the references are weak references, however, they are ignored by the pointer tracer in the garbage collector 105 during the memory reclamation process.

FIG. 6 is an example of the data structure 109 which is illustrated in FIG. 4 after the memory occupied by the objects which were no longer reachable from outside of the data structure is automatically reclaimed by the garbage collector 105, notwithstanding that some of the objects are still referenced in the index 111. Objects 21, 327, and 45 have been completely removed from FIG. 6, thus illustrating the reclamation of the memory which they previously occupied.

During the memory reclamation process, the garbage collector 105 may be configured to store references to objects whose memory has been reclaimed in a reference reclamation queue.

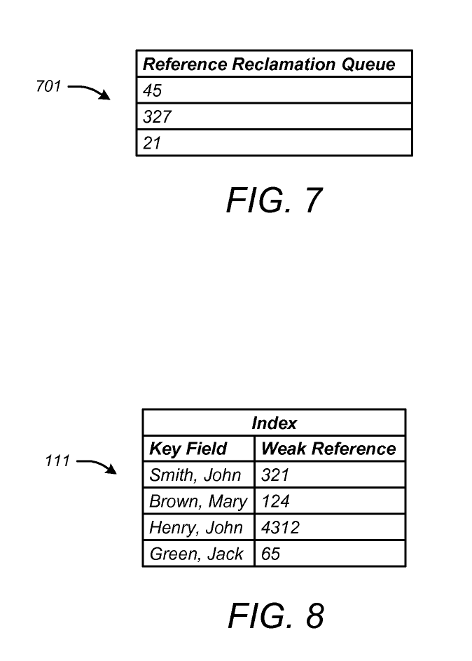

FIG. 7 is an example of a reference reclamation queue 701 created by the garbage collector illustrated in FIG. 1 after reclaiming the memory, as illustrated in FIG. 6. As illustrated in FIG. 7, the reference reclamation queue 701 may include references to the objects 45, 327, and 21, whose memory was reclaimed, as illustrated in FIGS. 5 and 6.

The application program 103 may be configured to read the references that are in the reference reclamation queue 701, as reflected by a Read Reference Reclamation Queue step 209. The application program 103 may be configured to do so after directing that a change be made to one or more of the objects in the data structure 109, and after being informed that the garbage collector 105 has completed a memory reclamation cycle.

The application program 103 may be configured to remove entries in the index 111 to objects whose memory has been reclaimed by the garbage collector 105 during a memory reclamation process, as reflected by a Remove Entries in Index To Unreachable Object(s) step 211. These may be the objects identified by the references which the application program 103 read from the reference reclamation queue 701.

FIG. 8 is an example of the index 111 which is illustrated in FIG. 1 after entries which refer to unreachable objects have been removed by the application program 103. As illustrated in FIG. 8, the previously-existing entries in the index 111 for no longer reachable objects 327 and 21 have been removed.

The computer programs which have been discussed herein, such as the application program 103, may be stored on non-transitory, tangible, computer-readable storage media, such as one or more CD's, DVD's, flash memories, and/or hard disk drives.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

For example, the technology which has been described may be used for indexing a subset of a social network, a content management system for rich media publishing, and/or a universe of financial instruments, including their attributes, and relationships.

Unless otherwise stated, all measurements, values, ratings, positions, magnitudes, sizes, and other specifications which are set forth in this specification, including in the claims which follow, are approximate, not exact. They are intended to have a reasonable range which is consistent with the functions to which they relate and with what is customary in the art to which they pertain.

All articles, patents, patent applications, and other publications which have been cited in this disclosure are incorporated herein by reference.

The phrase “means for” when used in a claim is intended to and should be interpreted to embrace the corresponding structures and materials which have been described and their equivalents. Similarly, the phrase “step for” when used in a claim is intended to and should be interpreted to embrace the corresponding acts which have been described and their equivalents. The absence of these phrases in a claim mean that the claim is not intended to and should not be interpreted to be limited to any of the corresponding structures, materials, or acts or to their equivalents.

None of the claims are intended to embrace non-statutory subject matter, such as an abstract idea, law of nature or natural phenomena; obvious subject matter; nor subject matter lacking novelty, nor should they be interpreted in such a way. Any unintended embracement of such subject matter is hereby disclaimed.

Except as otherwise stated immediately above, nothing which has been stated or illustrated is intended or should be interpreted to cause a dedication of any component, step, feature, object, benefit, advantage, or equivalent to the public, regardless of whether it is recited in the claims.

The scope of protection is limited solely by the claims which now follow. That scope is intended and should be interpreted to be as broad as is consistent with the ordinary meaning of the language which is used in the claims when interpreted in light of this specification and the prosecution history which follows and to encompass all structural and functional equivalents.

The invention claimed is:

1. Non-transitory, tangible, computer-readable memory which is managed by a garbage collector, the memory containing:
a data structure which includes a plurality of objects; and
an index which indexes a plurality of the objects in the data structure, the index containing for each object which it indexes:
a key field indicative of an attribute of the object; and
a reference to the object which is associated with the key field in a format which does not prevent the garbage collector from reclaiming memory occupied by any object in the data structure which is no longer reachable from outside of the data structure, even though the object is still referenced by the index.

2. The non-transitory, tangible, computer memory of claim 1 wherein all of the references to each object in the index are weak references.

3. The non-transitory, tangible, computer memory of claim 1 wherein:
the data structure includes a plurality of object groups; and
the reference to each object has a format which does not prevent the garbage collector from reclaiming memory occupied by any object group in the data structure which is no longer reachable from outside of the data structure, even though an object within the object group is still referenced by the index.

4. The non-transitory, tangible, computer memory of claim 1 wherein the data structure is an arbitrary data structure.

5. The non-transitory, tangible, computer memory of claim 4 wherein the data structure is arbitrarily complex.

6. The non-transitory, tangible, computer memory of claim 1 wherein the data structure is a cyclical data structure.

7. The non-transitory, tangible, computer memory of claim 1 wherein the objects include nodes and edges of a graph.

8. The non-transitory, tangible, computer memory of claim 1 wherein the index is implemented as a hash map.

9. Non-transitory, tangible, computer-readable storage media containing computer-readable instructions which, when executed by a computer system, cause the computer system to:
write a data structure which includes a plurality of objects into non-transitory, tangible, computer-readable memory which is managed by a garbage collector; and
write into an index the memory which indexes a plurality of the objects in the data structure, the index containing for each object which it indexes:
a key field indicative of an attribute of the object; and
a reference to the object which is associated with the key field in a format which does not prevent the garbage collector from reclaiming memory occupied by any object in the data structure which is no longer reachable from outside of the data structure, even though the object is still referenced by the index.

10. The non-transitory, tangible, computer-readable storage media of claim 9 wherein the instructions, when executed by the computer system, cause the computer system to remove entries in the index to objects whose memory has been reclaimed by the garbage collector.

11. The non-transitory, tangible, computer-readable storage media of claim 10 wherein the instructions, when executed by the computer system, cause the computer system to identify objects whose memory has been reclaimed by the garbage collector by reading references to those objects from a reference reclamation queue.

12. The non-transitory, tangible, computer-readable storage media of claim 11 wherein the reference reclamation queue is a queue created by the garbage collector.

13. The non-transitory, tangible, computer-readable storage media of claim 9 wherein the instructions are part of an application program which is separate from the garbage collector and which does not contain any instructions which reclaim memory occupied by any of the objects in the data structure which are no longer reachable from outside of the data structure.

14. The non-transitory, tangible, computer memory of claim 9 wherein all of the references to each object in the index are weak references.

15. The non-transitory, tangible, computer memory of claim 9 wherein:
the data structure includes a plurality of object groups; and
the reference to each object has a format which does not prevent the garbage collector from reclaiming memory occupied by any object group in the data structure which is no longer reachable from outside of the data structure, even though an object within the object group is still referenced by the index.

16. The non-transitory, tangible, computer memory of claim 9 wherein the data structure is an arbitrary data structure.

17. The non-transitory, tangible, computer memory of claim 17 wherein the data structure is arbitrarily complex.

18. The non-transitory, tangible, computer memory of claim 9 wherein the data structure is a cyclical data structure.

19. The non-transitory, tangible, computer memory of claim 9 wherein the objects include nodes and edges of a graph.

20. The non-transitory, tangible, computer memory of claim 9 wherein the index is implemented as a hash map.
